(19) United States
(12) Patent Application Publication
(10) Pub. No.: US 2015/0090658 A1
(43) Pub. Date: Apr. 2, 2015

(54) Fiber having a Nanohair Surface Topography

(71) Applicant: Kimberly-Clark Worldwide, Inc., Neenah, WI (US)

(72) Inventors: Kelly Branham, Woodstock, GA (US); Sara Honarbakhsh, Sandy Springs, GA (US)

(73) Assignee: Kimberly-Clark Worldwide, Inc., Neenah, WI (US)

(21) Appl. No.: 14/041,205

(22) Filed: Sep. 30, 2013

(51) Int. Cl. B01D 39/16; D04H 1/4391; D01D 5/08; D02G 3/34

(52) U.S. Cl. CPC B01D 39/163; D02G 3/34; D04H 1/4391; D01D 5/082
USPC 210/491; 428/394; 428/391; 428/372; 442/333; 428/219; 264/211; 264/466; 264/464; 210/504; 210/490; 55/524; 55/486

(57) ABSTRACT

A fiber that has a unique surface topography in that it contains a plurality of nanohairs extending outwardly from an external surface of an elongate structure of the fiber is provided. To form the nanohairs, a polymer composition is spun that includes organofunctional nanoparticles (e.g., polyhedral organofunctional silsesquioxanes) embedded within a matrix of a base polymer. Despite being initially embedded within the polymer, the present inventors have discovered that, through selective control over the nature and relative concentration of the components of the composition, as well as the method in which the fiber is formed, a substantial portion of the nanoparticles can migrate to the surface of the fiber as it is formed and thus become arranged in the form of nanohairs.

### BACKGROUND OF THE INVENTION

Meltblown webs are often used as filtration media, either alone or in combination with one or more spunbond webs. More particularly, the densely packed fine fibers of conventional meltblown webs can provide for a very small interfiber pore structure, which is highly suitable for mechanically trapping or screening particles. Unfortunately, however, the small pore structure of meltblown webs also results in a low permeability, which creates a high pressure drop across the web during use, thereby dictating the use of a high driving pressure to establish an adequate filtration throughput rate. Furthermore, as contaminants accumulate on the surface of the filter media, they can quickly clog the small pores and further reduce the permeability of the filtration media, thereby even further increasing the pressure drop across the media and rapidly shortening the service life. As such, a need currently exists for a filter media that is capable of achieving a high filtration efficiency, yet also exhibiting a relatively low pressure drop.

### SUMMARY OF THE INVENTION

In accordance with one embodiment of the present invention, a fiber is disclosed that comprises an elongate structure that defines an external surface. A plurality of nanohairs extend outwardly from the external surface. Further, organofunctional nanoparticles form about 70 wt. % or more of the nanohairs and one or more thermoplastic polymers form about 70 wt. % or more of the elongate structure.

In accordance with another embodiment of the present invention, a method for forming a fiber is disclosed. The method comprises spinning a polymer composition to form an elongate structure having an external surface. The polymer composition comprises organofunctional nanoparticles embedded within a matrix of one or more thermoplastic polymers. Further, a plurality of nanohairs extend outwardly from the external surface of the elongate structure.

Other features and aspects of the present invention are discussed in greater detail below.

### BRIEF DESCRIPTION OF THE DRAWINGS

A full and enabling disclosure of the present invention, including the best mode thereof, directed to one of ordinary skill in the art, is set forth more particularly in the remainder of the specification, which makes reference to the appended figures in which:

FIG. 1 is a top view of a fiber collection surface that may be employed in one embodiment of the present invention;

FIG. 2 is a perspective view of the fiber collection surface of FIG. 1;

FIG. 3 is an SEM microphotograph of Sample 2 formed in Example 1 (15 wt. % polyhedral oligomeric silsesquioxane (“POSS”)) at a magnification of 5600×;

FIG. 4 is an SEM microphotograph of Sample 3 formed in Example 1 (10 wt. % polyhedral oligomeric silsesquioxane (“POSS”)) at a magnification of 16,000×;

FIG. 5 is an SEM microphotograph of Sample 5 formed in Example 1 (10 wt. % polyhedral oligomeric silsesquioxane (“POSS”)) at a magnification of 23,000×;

FIG. 6 is an SEM microphotograph of Sample 6 formed in Example 1 (15 wt. % polyhedral oligomeric silsesquioxane (“POSS”)) at a magnification of 7,500×;

FIG. 7 is an SEM microphotograph of Sample 7 formed in Example 1 (10 wt. % polyhedral oligomeric silsesquioxane (“POSS”)) at a magnification of 8,300×;

FIG. 8 is an SEM microphotograph of Sample 17 formed in Example 2 (15 wt. % polyhedral oligomeric silsesquioxane (“POSS”)) at a magnification of 11,500×; and

FIGS. 9-11 are SEM microphotographs of fibers formed in Example 3 (10 wt. % titanium dioxide) at magnification levels of 2650×, 4300×, and 4300×.

### DETAILED DESCRIPTION OF REPRESENTATIVE EMBODIMENTS

### Definitions

As used herein, the term “fiber” generally refers to an elongate structure that either has a definite length or is substantially continuous in nature.

As used herein, the term “nanofiber” generally refers to a fiber in which the elongate structure has an average width (e.g., diameter) of less than about 1 micrometer, in some embodiments about 800 nanometers or less, in some embodiments from about 5 nanometers to about 500 nanometers, and in some embodiments, from about 10 nanometers to about 100 nanometers.

As used herein, the term “microfiber” generally refers to a fiber in which the elongate structure has an average width (e.g., diameter) of from about 1 micrometer to about 100 micrometers, in some embodiments about 2 micrometers to about 50 micrometers, in some embodiments from about 3 micrometers to about 40 micrometers, and in some embodiments, from about 5 micrometers to about 25 micrometers.

As used herein, the term “meltblown” web generally refers to a nonwoven web that is formed by a process in which a molten thermoplastic material is extruded through a plurality of fine, usually circular, die capillaries as molten fibers into converging high velocity gas (e.g., air) streams that attenuate the fibers of molten thermoplastic material to reduce their diameter. Thereafter, the meltblown fibers are carried by the high velocity gas stream and are deposited on a collecting surface to form a web of randomly dispersed meltblown fibers.

As used herein, the term “spunbond” web generally refers to a nonwoven web containing substantially continuous filaments. The filaments are formed by extruding a molten thermoplastic material from a plurality of fine, usually circular, capillaries of a spinnerette with the diameter of the extruded filaments then being rapidly reduced as by, for example, eductive drawing and/or other well-known spunbonding mechanisms.

### DETAILED DESCRIPTION

Reference now will be made in detail to various embodiments of the invention, one or more examples of which are set forth below. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment, can be used on another embodiment to yield a still further embodiment. Thus, it is intended that the present invention covers such modifications and variations within the scope of the appended claims and their equivalents.

Generally speaking, the present invention is directed to a fiber (e.g., nanofiber or microfiber) that has a unique surface topography in that it contains a plurality of nanohairs extending outwardly from an external surface of an elongate structure of the fiber. In certain embodiments, for example, the nanohairs are positioned axially about the surface of the elongate structure. The nanohairs have a very high aspect ratio (length divided by width). For example, the nanohairs may have an aspect ratio of from about 1 to about 1,000 in some embodiments from about 1.5 to about 800, and in some embodiments, from about 10 to about 500. The length of the nanohairs may, for example, range from about 100 to about 3,000 nanometers, in some embodiments from about 200 to about 2,000 nanometers, and in some embodiments, from about 350 to about 1,000 nanometers. Likewise, the width of the nanohairs may range from about 1 to about 500 nanometers, in some embodiments from about 2 to about 450 nanometers, and in some embodiments, from about 0.5 to about 400 nanometers.

To form the nanohair surface topography, a polymer composition may be spun that includes organofunctional nanoparticles (e.g., polyhedral organofunctional silsesquioxanes) embedded within a matrix of one or more thermoplastic polymers. Despite being initially embedded within the polymer matrix, the present inventors have discovered that, through selective control over the nature and relative concentration of the components of the composition, as well as the method in which the fiber is formed, a substantial portion of the nanoparticles can migrate to the surface of the fiber as it is formed and thus become arranged in the form of nanohairs. For example, in one embodiment, an electrostatic charge may be applied to the fibers as they are formed (e.g., by applying a charge to the fiber collecting surface), which can facilitate aggregation and stacking of the nanoparticles as they move towards the fiber surface. Rather than simply being deposited as individual particles, the aggregation and stacking of the nanoparticles helps to form a nanohair surface topography.

Due to the unique surface topography achieved by the present invention, the present inventors have discovered that the resulting fibers are particularly useful in forming fibrous webs (e.g., nonwoven webs) used in filtration media. More particularly, the presence of the high aspect ratio nanohairs can dramatically increase the surface area of the fiber, thus improving its ability to trap contaminant particles, dust, etc. This can result in an improved filtration efficiency in comparison to media having the same basis weight. Alternatively, lower basis weight materials can be used to achieve approximately the same filtration efficiency as a higher basis weight material. For example, the filtration efficiency may, for example, be about 70% or more, in some embodiments about 80% or more, and in some embodiments, from about 85% to about 99%. The improved filtration efficiencies can also be achieved in the present invention at a relatively low pressure drop. For example, the pressure drop across the filtration media may be about 60 mm H₂O or less, in some embodiments about 50 mm H₂O or less, and in some embodiments, from about 10 to about 40 mm H₂O, as determined in accordance with ASTM F 778-88 (2007). The properties of filtration efficiency and pressure drop for a given filtration media can be quantified in combination by a value known as the Dynamic Filtration Property (“DFP”), which is determined according to the following equation:

$$Dynamic Filtration Property ( “ DFP ” ) = \frac{- ln [ ( 100 \text{-} \% Filtration Efficiency ) \text{/} 100 ]}{Pressure Drop ( mm {H}_{2} O )}$$

Typically, larger DFP values are a reliable indicator of better overall filtration performance. For example, the filtration media of the present invention may exhibit a DFP value of about 0.15 (mm H₂O)⁻¹ or more, in some embodiments about 0.20 (mm H₂O)⁻¹ or more, and in some embodiments, from about 0.25 to about 0.95 (mm H₂O)⁻¹.

Various embodiments of the present invention will now be described in more detail.

### I. Polymer Composition

A. Organofunctional Nanoparticles

As noted above, the nanohairs of the present invention are generally formed from organofunctional nanoparticles, which may be stacked or otherwise arranged together to form the desired surface topography. Typically, such nanoparticles constitute about 70 wt. % or more, in some embodiments about 80 wt. % or more, and in some embodiments, from about 90 wt. % to about 99.9 wt. % of the nanohairs. Organofunctional nanoparticles may likewise constitute from about 1 wt. % to about 40 wt. %, in some embodiments from about 5 wt. % to about 30 wt. %, and in some embodiments, from about 10 wt. % to about 25 wt. % of the polymer composition.

To help achieve the desired nanohair topography, it is typically desired that the molecular size of the organofunctional nanoparticles is in the nano-scale range, such as about 50 nanometers or less, in some embodiments about 20 nanometers or less, and in some embodiments, from about 0.5 to about 5 nanometers. The density of the nanoparticles is likewise relatively low, such as about 1.8 grams per cubic centimeter (g/cm³) or less, in some embodiments about 1.5 g/cm³ or less, and in some embodiments, from about 0.8 to about 1.4 g/cm³.

Any of a variety of organofunctional nanoparticles that have the desired size and/or density may generally be employed in the polymer composition. Examples of such nanoparticles may include, for instance, organotitanates, such as alkyl titanates (e.g., tetrabutyl orthotitanate); organofunctional aluminum oxides (e.g., aluminum acetylacetonate, aluminum butoxide, aluminum isopropoxide, etc.); organosilicates, such as alkyl silicates (e.g., tetraethyl orthosilicate, tetrabutyl orthotitanate, etc.); organosiloxane oligomers; and so forth. Particularly suitable are polyhedral organofunctional siloxane oligomers that include the group of spherosilicates known as silsesquioxanes. Silsequioxanes, which are often referred to by the acronym “POSS”, are polycyclic compounds formed from silicon and oxygen atoms with at least one silicon atom covalently linked to an organofunctional group. Silsesquioxanes can be fully or partially hydrolyzed. Fully hydrolyzed silsesquioxanes have the empirical chemical formula RSiO_{1.5}, where R is either hydrogen or an organofunctional group, wherein at least one R in the molecule is typically an organofunctional group. Such silsesquioxane molecules generally contain a silica cage with organofunctional groups attached at the corners of the cage, such as represented by the structure below:

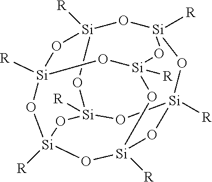

Suitable organofunctional groups (“R”) may include, for instance, alkyl (e.g., methyl, ethyl, propyl, butyl, etc.), aryl (e.g., phenyl), cycloalkyl (e.g., cyclopentyl), arylenyl, alkenyl, cycloalkenyl (e.g., cyclohexenyl), alkoxy, amino, ureido, epoxy, vinyl, cyanato, urethane, methacrylato, isocyanate, acrylic, sulfane, mercapto, silanol, halo (e.g., fluoro), silicone, etc., as well as combinations thereof. Homoleptic oligomer systems contain only one type of organofunctional group while heteroleptic systems contain more than one type of organofunctional group. Particular examples of suitable POSS oligomers include, for instance, cyclohexenyl-POSS; cyclohexenylethylcyclopentyl-POSS; trisilanol phenyl-POSS; octaisobutyl-POSS; phenylisooctyl-POSS; isooctylphenyl-POSS; isobutylphenyl-POSS; poly(dimethyl-co-methyl-co-methylethylsiloxy)-POSS; methacrylfluoro-POSS; etc.

B. Thermoplastic Polymer

To provide adequate thermal and mechanical properties, it is generally desired that thermoplastic polymers form a substantial portion of the elongate structure of the fiber. That is, thermoplastic polymers may constitute about 70 wt. % or more, in some embodiments about 80 wt. % or more, and in some embodiments, from about 90 wt. % to about 99.9 wt. % of the elongate structure of the fiber. In this regard, the polymer composition may likewise contain from about 50 wt. % to about 90 wt. %, in some embodiments from about 70 wt. % to about 80 wt. %, and in some embodiments, from about 80 wt. % to about 95 wt. % of thermoplastic polymers.

Any of a variety of different polymers or blends of polymers may be employed in the present invention. Exemplary polymers may include, for instance, polyolefins, polytetrafluoroethylene, polyesters (e.g., polyethylene terephthalate, polylactic acid, etc.), polyvinyl acetate, polyvinyl chloride acetate, polyvinyl butyral, acrylic resins, (e.g., polyacrylate, polymethylacrylate, polymethylmethacrylate, etc.), polyamides (e.g., nylon), blends thereof, and so forth. Polyolefins may be particularly suitable for use in the present invention. When employed, the polyolefin may have a melting temperature of from about 100° C. to about 220° C., in some embodiments from about 120° C. to about 200° C., and in some embodiments, from about 140° C. to about 180° C., such as determined using differential scanning calorimetry (“DSC”) in accordance with ASTM D-3417. Suitable polyolefins may, for instance, include ethylene polymers (e.g., low density polyethylene (“LDPE”), high density polyethylene (“HDPE”), linear low density polyethylene (“LLDPE”), etc.), propylene homopolymers (e.g., syndiotactic, atactic, isotactic, etc.), propylene copolymers, and so forth. In one particular embodiment, the polymer is a propylene polymer, such as homopolypropylene or a copolymer of propylene. The propylene polymer may, for instance, be formed from a substantially isotactic polypropylene homopolymer or a copolymer containing equal to or less than about 10 wt. % of other monomers, i.e., at least about 90% by weight propylene. Such homopolymers may have a melting point of from about 140° C. to about 170° C. Commercially available propylene homopolymers may include, for instance, Metocene™ MF650Y and MF650X, which are available from Basell Polyolefins.

Of course, other polyolefins may also be employed in the composition of the present invention. In one embodiment, for example, the polyolefin may be a copolymer of ethylene or propylene with another α-olefin, such as a C₃-C₂₀ α-olefin or C₃-C₁₂ α-olefin. Specific examples of suitable α-olefins include 1-butene; 3-methyl-1-butene; 3,3-dimethyl-1-butene; 1-pentene; 1-pentene with one or more methyl, ethyl or propyl substituents; 1-hexene with one or more methyl, ethyl or propyl substituents; 1-heptene with one or more methyl, ethyl or propyl substituents; 1-octene with one or more methyl, ethyl or propyl substituents; 1-nonene with one or more methyl, ethyl or propyl substituents; ethyl, methyl or dimethyl-substituted 1-decene; 1-dodecene; and styrene. Particularly desired α-olefin comonomers are 1-butene, 1-hexene and 1-octene. The ethylene or propylene content of such copolymers may be from about 60 mole % to about 99 mole %, in some embodiments from about 80 mole % to about 98.5 mole %, and in some embodiments, from about 87 mole % to about 97.5 mole %. The α-olefin content may likewise range from about 1 mole % to about 40 mole %, in some embodiments from about 1.5 mole % to about 15 mole %, and in some embodiments, from about 2.5 mole % to about 13 mole %.

Exemplary olefin copolymers for use in the present invention include ethylene-based copolymers available under the designation EXACT™ from ExxonMobil Chemical Company of Houston, Tex. Other suitable ethylene copolymers are available under the designation ENGAGE™, AFFINITY™, DOWLEX™ (LLDPE) and ATTANE™ (ULDPE) from Dow Chemical Company of Midland, Mich. Other suitable ethylene polymers are described in U.S. Pat. No. 4,937,299 to Ewen et al.; U.S. Pat. No. 5,218,071 to Tsutsui et al.; U.S. Pat. No. 5,272,236 to Lai, et al.; and U.S. Pat. No. 5,278,272 to Lai, et al. Suitable propylene copolymers are also commercially available under the designations VISTAMAXX™ from ExxonMobil Chemical Co. of Houston, Tex.; FINA™ (e.g., 8573) from Atofina Chemicals of Feluy, Belgium; TAFMER™ available from Mitsui Petrochemical Industries; and VERSIFY™ available from Dow Chemical Co. of Midland, Mich. Suitable polypropylene homopolymers may include Exxon Mobil 3155 polypropylene, Exxon Mobil Achieve™ resins, and Total M3661 PP resin. Other examples of suitable propylene polymers are described in U.S. Pat. No. 6,500,563 to Datta, et al.; U.S. Pat. No. 5,539,056 to Yang, et al.; and U.S. Pat. No. 5,596,052 to Resconi, et al.

C. Charge Stabilizer

As will be described in more detail below, an electrostatic charge may be applied to the fibers as they are formed (e.g., to the collection surface) to help create the desired nanohair surface topography. In certain cases, however, the thermoplastic polymer can act as an insulator and thus limit the ability of the charge to be accepted by the polymer composition. To help ameliorate the insulating effect of the thermoplastic polymer and enhance its ability to accept a charge, a charge stabilizer may be employed in certain embodiments of the present invention. When employed, such charge stabilizers may be present in any effective amount needed, such as from about 0.001 wt. % to about 5 wt. %, in some embodiments from about 0.005 wt. % to about 2 wt. %, and in some embodiments, from about 0.01 wt. % to about 1 wt. % of the polymer composition.

While any suitable charge stabilizer may generally be employed in the present invention, particularly suitable stabilizers include salts or esters of organic carboxylic acids. For example, the stabilizer may be a salt of an organic carboxylic acid represented by the formula R₁[C(O)O⁻]ₙMⁿ⁺, wherein M is a metal ion (e.g., alkali metal ion, such as sodium or potassium), n is a number representing the valence of the metal ion, and R₁ is an organic radical containing from 5 to 30 carbon atoms, in some embodiments from 8 to 22 carbon atoms, and in some embodiments, from 12 to 22 carbon atoms (e.g., aliphatic hydrocarbyl group). Examples of such salts may include, for instance, an alkali metal salt of a C₆-C₃₀ fatty acid, such as sodium oleate, potassium oleate, sodium stearate, potassium stearate, sodium laurate, potassium laurate, sodium linoleate, etc. Esters (e.g., monoesters, diesters, etc.) of an organic carboxylic acid may also be employed, such as fatty acid esters (e.g., methyl stearate, ethyl stearate, methyl oleate, ethyl oleate, n-butyl oleate, t-butyl oleate, methyl laurate, ethyl laurate, methyl linoleate, ethyl linoleate, methyl palpitate, etc.); aromatic acid esters (e.g., methyl phthalate, ethyl phthalate, methoxy ethyl phthalate, ethoxyethylphthalate, di(ethoxyalkyl)phthalate, di(butoxyethyl)phthalate, di(butoxyethoxyethyl)phthalate, dioctyl phthalate, dibutylterephthalate, etc.); and so forth.

D. Other Components

Although not required, a variety of other additives may also be employed in the polymer composition, such as catalysts, antioxidants, peroxides, surfactants, spinning aids, waxes, nucleating agents, particulates, and other materials added to enhance processability or impart other properties to the fibers.

### II. Blending

The components of the polymer composition may be blended together for spinning using any of a variety of known techniques, including melt blending, solution blending, etc. In one embodiment, for example, the components (e.g., polymer, organofunctional nanoparticles, charge stabilizer, etc.) may be supplied to a melt blending device separately or in combination. For instance, the components may first be dry mixed together to form an essentially homogeneous dry mixture, and they may likewise be supplied either simultaneously or in sequence to a melt processing device that dispersively blends the materials. Batch and/or continuous melt processing techniques may be employed. For example, a mixer/kneader, Banbury mixer, Farrel continuous mixer, single-screw extruder, twin-screw extruder, roll mill, etc., may be utilized to blend and melt process the materials. Particularly suitable melt processing devices may be a co-rotating, twin-screw extruder (e.g., ZSK-30 extruder available from Werner & Pfleiderer Corporation of Ramsey, N.J. or a Thermo Prism™ USALAB 16 extruder available from Thermo Electron Corp., Stone, England). Such extruders may include feeding and venting ports and provide high intensity distributive and dispersive mixing. For example, the components may be fed to the same or different feeding ports of the twin-screw extruder and melt blended to form a substantially homogeneous melted mixture. If desired, other additives may also be injected into the polymer melt and/or separately fed into the extruder at a different point along its length.

The degree of shear/pressure and heat may also be controlled to ensure sufficient dispersion. For example, blending typically occurs at a temperature of from about 180° C. to about 260° C., in some embodiments from about 185° C. to about 250° C., and in some embodiments, from about 190° C. to about 240° C. Likewise, the apparent shear rate during melt processing may range from about 10 seconds⁻¹ to about 3000 seconds⁻¹, in some embodiments from about 50 seconds⁻¹ to about 2000 seconds⁻¹, and in some embodiments, from about 100 seconds⁻¹ to about 1200 seconds⁻¹. The apparent shear rate is equal to 4Q/πR³, where Q is the volumetric flow rate (“m³/s”) of the polymer melt and R is the radius of the capillary (e.g., extruder die) through which the melted polymer flows. Of course, other variables, such as the residence time during melt processing, which is inversely proportional to throughput rate, may also be controlled to achieve the desired degree of homogeneity. To achieve the desired shear conditions (e.g., rate, residence time, shear rate, melt processing temperature, etc.), the speed of the extruder screw(s) may be selected with a certain range. For example, the screw speed may range from about 50 to about 300 revolutions per minute (“rpm”), in some embodiments from about 70 to about 500 rpm, and in some embodiments, from about 100 to about 300 rpm. The melt shear rate, and in turn the degree to which the components are dispersed, may also be increased through the use of one or more distributive and/or dispersive mixing elements within the mixing section of the extruder. Suitable distributive mixers for single screw extruders may include, for instance, Saxon, Dulmage, Cavity Transfer mixers, etc. Likewise, suitable dispersive mixers may include Blister ring, Leroy/Maddock, CRD mixers, etc. As is well known in the art, the mixing may be further improved by using pins in the barrel that create a folding and reorientation of the polymer melt, such as those used in Buss Kneader extruders, Cavity Transfer mixers, and Vortex Intermeshing Pin (VIP) mixers.

### III. Fiber Formation

Generally speaking, any of a variety of known spinning techniques may be employed in the present invention to form fibers, such as melt spinning, solution spinning, etc. In one particular embodiment, centrifugal spinning techniques are employed that involve the formation of fibers by a process that includes the ejection of dissolved or melted polymer from a rotating member (e.g., spinneret or spin disc) that propels the polymer composition by centrifugal force into the form of fibers. If desired, air may also be supplied (e.g., along the radial direction of the rotating member) to help attenuate and direct the fibers as they are formed. The rotating member may rotate at a speed of, for example, from about 500 to about 40,000 revolutions per minute (RPM), in some embodiments from about 1,000 to about 30,000 RPM, and in some embodiments, from about 5,000 to about 25,000 RPM. If desired, the temperature of the rotating member may also be controlled during fiber spinning. For example, the rotating member temperature may range from about 100° C. to about 500° C., and in some embodiments, from about 150° C. to about 300° C.

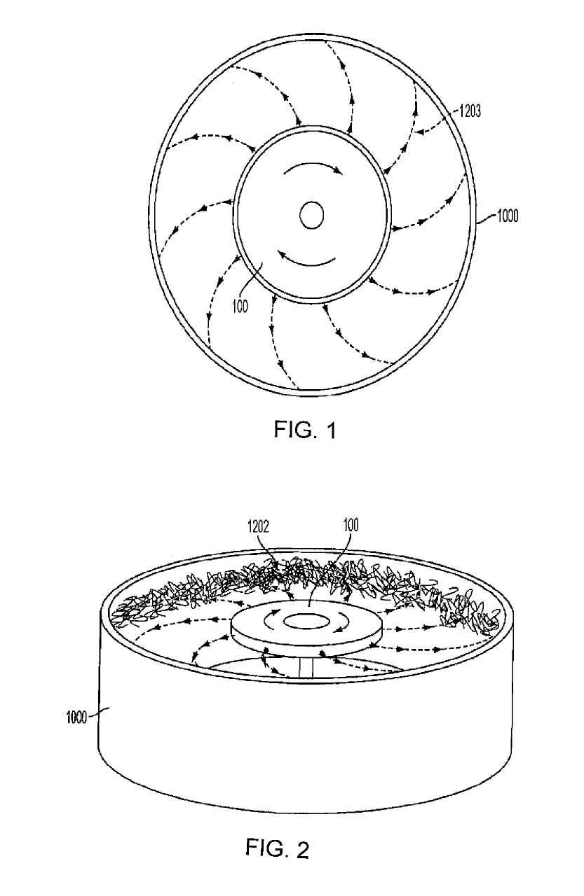

During centrifugal spinning, the fibers are distributed radially away from the rotating member onto a collection surface to form a coherent nonwoven web structure. The collection surface may vary as desired, and can be either stationary or rotated during collection of the fibers. In one embodiment, for example, the collection surface may be provided on a collection wall that surrounds the rotating member. In another embodiment, the collection surface may be in the form of a rod. Referring to FIGS. 1-2, for example, one embodiment is shown in which a generally circular collection wall 1000 is employed to help collect the fibers. More particularly, fibers 1202 may be spun clockwise about a spin axis in a rotating member 100, from which they exit along pathways 1203 and collect on an interior surface of the collection wall 1000.

Regardless of the particular nature of the spinning process, it is generally desired to apply an electrical charge to the polymer composition before and/or during fiber formation to help achieve the desired nanohair topography. While having a minimal impact on their formation, such an electrostatic charge may help the organofunctional nanoparticles separate from the base polymer and form nanohairs on the surface of the fibers. For example, the polymer composition may be charged while on the rotating member, or it may be charged as it is formed into fibers on the collecting surface. The polymer composition may be charged directly, such as by an ion current from a corona discharge produced by a charged entity proximate to the rotating member. One example of such a charged entity would be a ring carrying a current that is concentric with the rotating member and located proximate to the polymer composition, or to the fibers as they are formed. In yet another embodiment, the polymer composition may be charged relative to a collection surface, such that an electric field is present between the fibers and the collection surface. The collection surface may be grounded or charged directly, or indirectly, via a charged plate or other entity in its vicinity, for example below it is charged relative to the rotating member. In various embodiments, for example, a charge is only applied to the collection surface. Any voltage source (e.g., high voltage direct current or unipolar radio frequency high voltage source) may generally be employed to supply the electrostatic field. The source may have variable voltage settings, such as from 20 kV to about 80 kV, and also (−) and (+) polarity settings to permit adjustments in establishing the electrostatic field. The current drawn in the charging process is typically small, such as about 10 mA or less.

### IV. Fibrous Web

While the fibers of the present invention may be used alone, it is typically desired that they are formed into a coherent fibrous web structure. The fibrous web may be a “nonwoven” web to the extent that individual fibers are randomly interlaid, not in an identifiable manner as in a knitted fabric. The basis weight of the fibrous web may generally vary, but is typically from about 1 gram per square meter (“gsm”) to 150 gsm, in some embodiments from about 5 gsm to about 100 gsm, and in some embodiments, from about 15 gsm to about 50 gsm.

If desired, the fibrous web may contain the fibers of the present invention in combination with other types of fibers (e.g., staple fibers, filaments, etc.) and/or other materials (e.g., superabsorbent particles). For example, additional synthetic fibers may be utilized, such as those formed from polyolefins (e.g., polyethylene, polypropylene, polybutylene, etc.); polytetrafluoroethylene; polyesters (e.g., polyethylene terephthalate, polylactic acid, etc.); polyamides (e.g., nylon); polyvinyl chloride; polyvinylidene chloride; polystyrene; and so forth. The fibrous web may also contain pulp fibers, such as high-average fiber length pulp, low-average fiber length pulp, or mixtures thereof. One example of suitable high-average length fluff pulp fibers includes softwood kraft pulp fibers. Low-average length fibers may also be used in the composite. An example of suitable low-average length pulp fibers is hardwood kraft pulp fibers. Such composites may be formed using a variety of known techniques. The relative percentages of the additional fibers may vary over a wide range depending on the desired characteristics of the composite. For example, the fibrous web may contain from about 1 wt. % to about 60 wt. %, in some embodiments from 5 wt. % to about 50 wt. %, and in some embodiments, from about 10 wt. % to about 40 wt. % fibers of the present invention, as well as from about 40 wt. % to about 99 wt. %, in some embodiments from 50 wt. % to about 95 wt. %, and in some embodiments, from about 60 wt. % to about 90 wt. % additional fibers.

In certain embodiments of the present invention, the resulting nonwoven web may be subjected to an electret treatment to further improve its filtration properties as is known in the art. The term “electret” treatment generally refers to any process that places a charge in and/or on the web. Suitable electret treating processes include, but are not limited to, plasma-contact, electron beam, corona discharge and so forth. Particular examples of electret treatments are described in, for example, U.S. Pat. No. 4,215,682 to Kubic et al.; U.S. Pat. No. 4,375,718 to Wadsworth et al.; U.S. Pat. No. 4,588,537 to Klaase et al.; U.S. Pat. No. 4,592,815 to Makao; and U.S. Pat. No. 5,401,446 to Tsai et al. As an example, the nonwoven web can be subjected to electric fields having opposite polarities to one another. For example, a first side of the web may be initially subjected to a positive charge while the second or opposing side may be subjected to a negative charge. If desired, the first side may then be subjected to a negative charge and the second side to a positive charge thereby imparting permanent electrostatic charges in the material.

### V. Filtration Media

As indicated above, the fibrous web of the present invention may be employed alone or in combination with other materials to form a filtration media. In one embodiment, for example, the filtration media may be a multi-layered laminate structure containing at least one layer formed from the fibrous web of the present invention. Apart from the fibrous web of the present invention, additional layers of the laminate may include a nonwoven web (e.g., a melt-spun web, such as a meltblown or spunbond web), film, strands, etc. In one embodiment, for example, the laminate may contain the fibrous web of the present invention positioned between two spunbond webs. Various techniques for forming laminates of this nature are described in U.S. Pat. No. 4,041,203 to Brock et al.; U.S. Pat. No. 5,213,881 to Timmons, et al.; U.S. Pat. No. 5,464,688 to Timmons, et al.; U.S. Pat. No. 4,374,888 to Bornslaeaer; U.S. Pat. No. 5,169,706 to Collier, et al.; and U.S. Pat. No. 4,766,029 to Brock et al. Of course, the laminate may have other configurations and possess any desired number of layers, such as a spunbond/fibrous web/meltblown web/spunbond laminate, spunbond/fibrous web laminate, etc. In yet another embodiment, the laminate may include the fibrous web positioned adjacent to a film. Any known technique may be used to form a film, including blowing, casting, flat die extruding, etc. The film may be a mono- or multi-layered film, which may or may not be aperture to increase gas or liquid permeability. Any of a variety of polymers may generally be used to form a melt-spun nonwoven web or film used in the laminate structure, such as polyolefins (e.g., polyethylene, polypropylene, polybutylene, etc.); polytetrafluoroethylene; polyesters (e.g., polyethylene terephthalate, polylactic acid, etc.); polyamides (e.g., nylon); polyvinyl chloride; polyvinylidene chloride; polystyrene; and so forth. The basis weight of the composite filtration media may generally vary, but is typically from about 20 gsm to about 200 gsm, in some embodiments from about 30 gsm to about 150 gsm, and in some embodiments, from about 40 gsm to about 100 gsm. The composite may also be subjected to an electret treatment in the manner described above.

Regardless of its particular structure, the resulting filtration media may be employed in a wide variety of applications, such as in medical products (e.g., facemasks, wound dressings, sterilization wraps, etc.), vacuum cleaner bags, respirators, air filters (e.g., for engines), heating and/or air conditioner filters, water filters, and so forth.

The present invention may be better understood with reference to the following examples.

### Test Methods

### Pressure Drop:

The “pressure drop” of a material is the measure of the force required to pass a volume of air through the material. The pressure drop may be measured in units of millimeters of water in accordance with ASTM F 778-88 (2007). This test made be performed using a TSI, Inc. (St. Paul, Minn.) Model 8130 Automated Filter Tester (AFT).

### Filtration Efficiency:

The filtration efficiency of a material may be determined using a TSI, Inc. (St. Paul, Minn.) Model 8130 Automated Filter Tester (AFT). The Model 8130 AFT uses a compressed air nebulizer to generate a polydisperse aerosol of aqueous sodium chloride (2 wt. % in solution), which are then separated by size through the use of an impingement device and are subsequently dried to form solid sodium chloride particles that serve as the aerosol for measuring filter performance. The aerosol is characterized by having a count mean diameter of 0.06 μm and a mass mean diameter of 0.18 μm. Typical air flow rates are between 84.5 liters per minute and 85.5 liters per minute, and the sample area may be about 97.9 cm². The performance of the material can be expressed as the percentage of sodium chloride particles that penetrate the filter. Penetration is defined as transmission of a particle through the filter medium. The concentration of transmitted particles is detected downstream from the filter and compared to the concentration upstream of the filter. The percent penetration (% P) reflects the ratio of the downstream particle-concentration to the upstream particle concentration, with lower numbers generally being more desirable. Light scattering photometry may be used to detect the sodium chloride particles. From the percent penetration, the filtration efficiency may then be calculated as a percentage based on the equation:

Filtration Efficiency=100−%P.

### Example 1

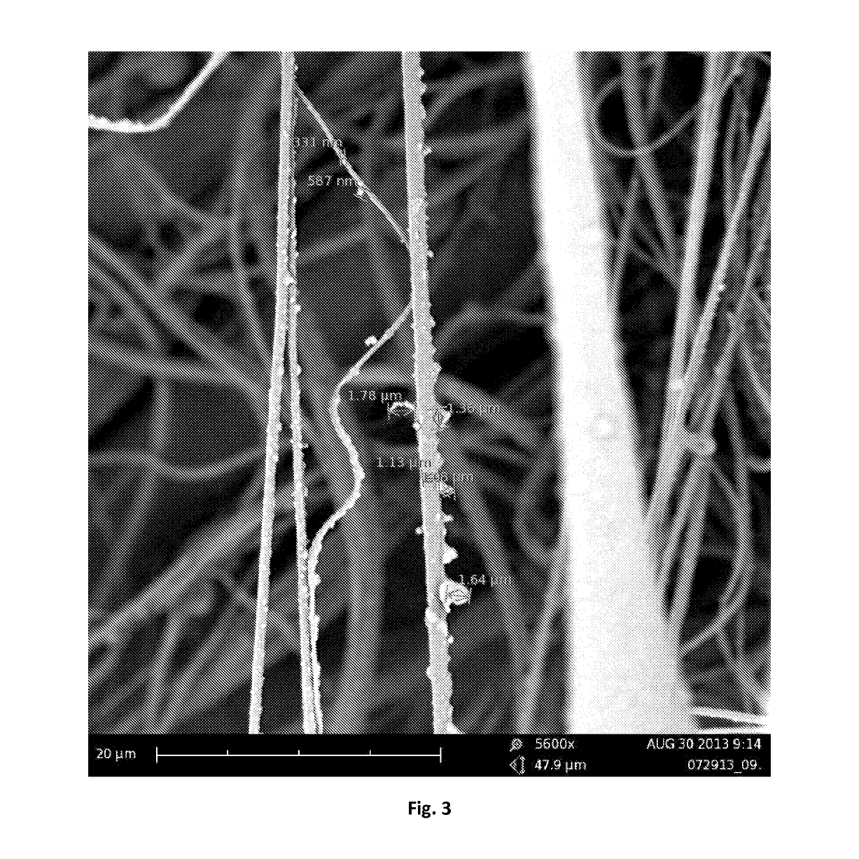

Eight (8) types of fibrous webs (Samples 1-8) were formed by dry blending a polypropylene masterbatch with a POSS masterbatch in a bucket or plastic bag. Samples 1, 3, 5, and 7 contained 50 wt. % of the polypropylene masterbatch and 50 wt. % of the POSS masterbatch, and Samples 2, 4, 6, and 8 contained 75 wt. % of the polypropylene masterbatch and 25 wt. % of the POSS masterbatch. In all samples, the polypropylene masterbatch contained 97 wt. % polypropylene (Metocene™ MF650Y, Basell Polyolefins), 1.5 wt. % peroxide masterbatch, and 1.5 wt. % sodium stearate and the POSS masterbatch contained 20 wt. % POSS particles and 80 wt. % Metocene™ MF650X. Once formed, the dry-blends were poured in a dry state into the hopper of a Forcespinning® system (FibeRio® Technology Corporation), which spun the blends into fibrous webs. The temperature of the extrusion zones of the spinning system ranged from 185° C. to 240° C. and the temperature of the hot runner (which flows the melt into the spinneret) was 240° C. Further, the flow rate from the melt pump into the hot runner was 8 ml/min. The spinneret also rotated at a rate of 6000 RPM and was set to a temperature between 370° C. and 390° C. SEM microphotographs of the resulting webs of Samples 2, 3, 5, 6, and 7 are shown in FIGS. 3-7, respectively. As shown, the POSS particles are capable of forming nanohairs on the surface of the polypropylene fibers.

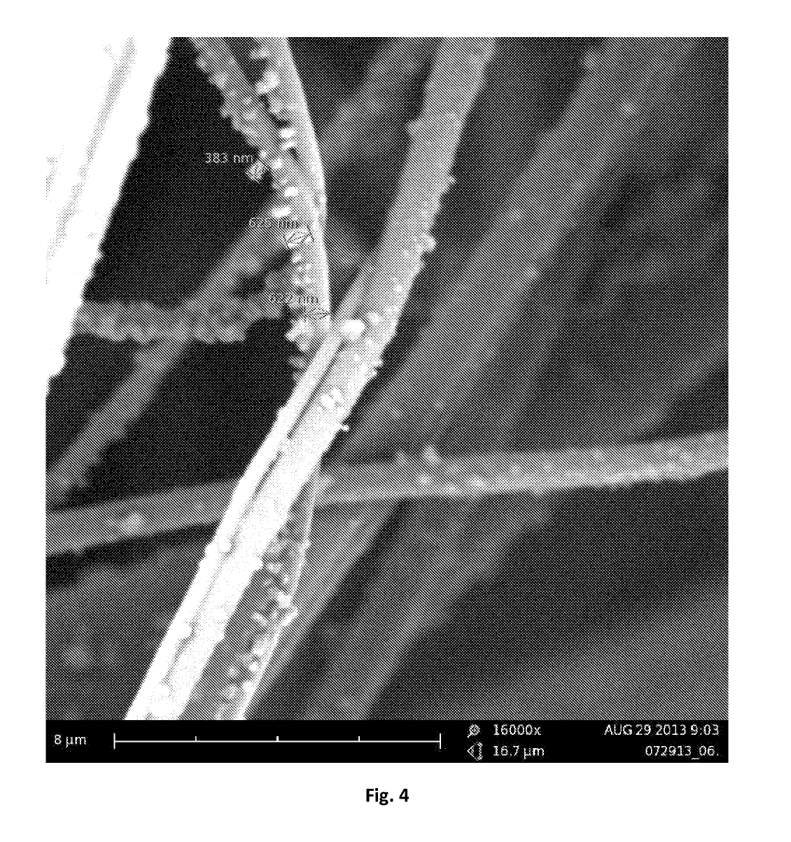

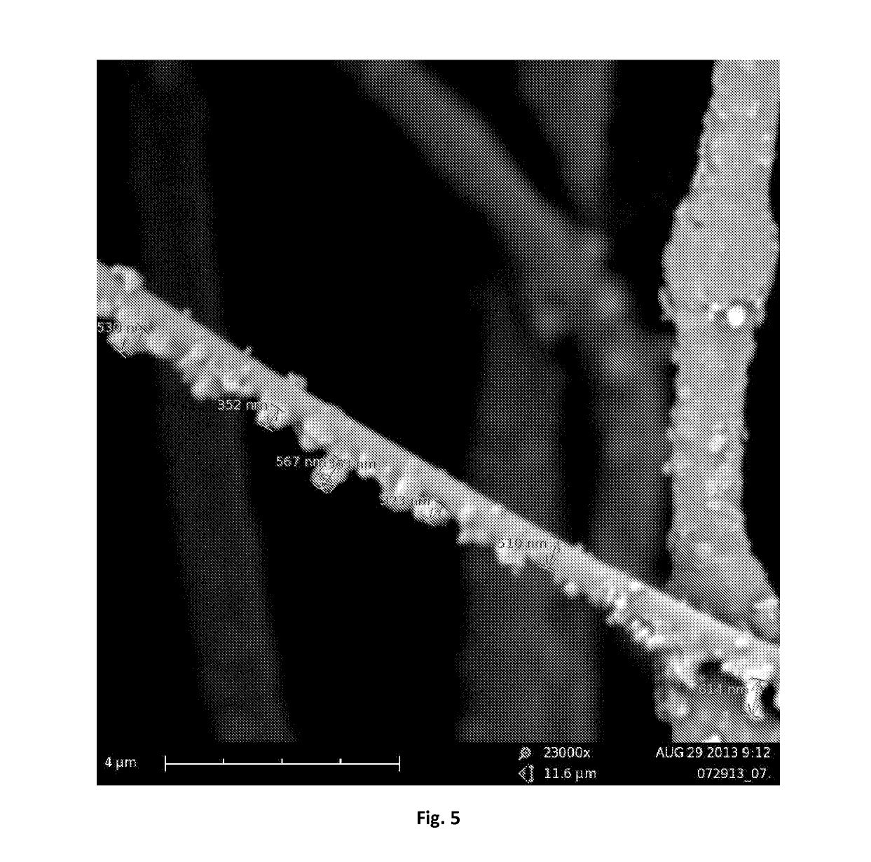

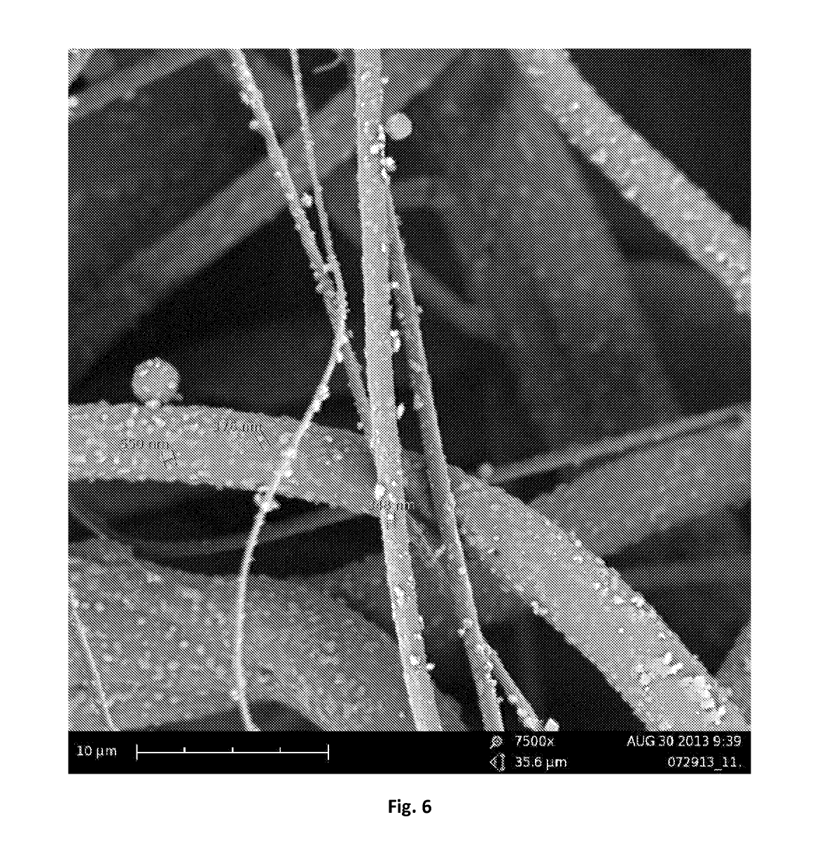

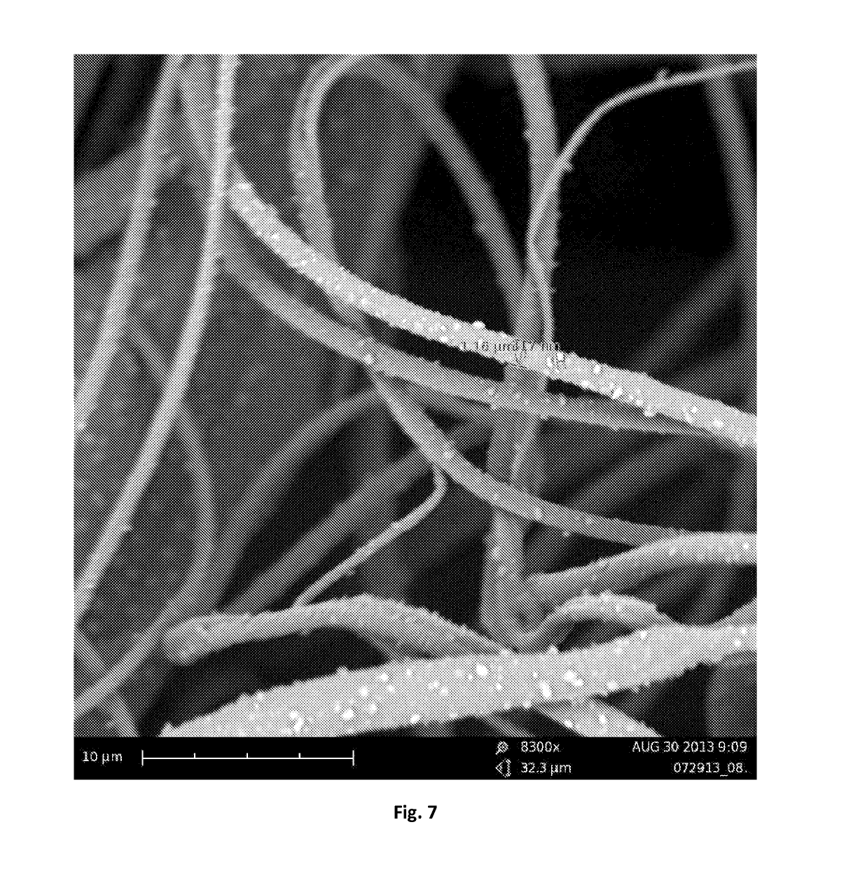

To test the ability of the fibrous webs to enhance filtration properties, three-layer laminates containing the fibrous web sandwiched between two bonded spunbond webs. The spunbond webs each had a basis weight of 20 grams per square meter. The samples were also subjected to an electret treatment. This was accomplished by passing the samples between a ground plate and electrode, and then applying 0-30 kVolts and 0-3 milliamps (at 1-2000 ft/min) using a power supply (Galssman High Voltage Inc.). A control sample (Control) was also formed that contained a meltblown web (target basis weight of 16 gsm) laminated between two spunbond webs (basis weight of 20 grams per square meter). The filtration efficiency and pressure drop were determined in the manner set forth above. The results are shown in the table below.

| | | | | | Avg. | Avg. | Dynamic |
|---|---|---|---|---|---|---|---|
| | | | Basis Wt. of | Basis Wt. of | Filtration | Pressure | Filtration |
| Sample | Process | Wt. % | Fibrous Web | Laminate | Efficiency | Drop | Property |
| (FIG. #) | Charge | POSS | (gsm) | (gsm) | (%) | (mm H₂O) | (mm H₂O)⁻¹ |
| Control | — | 0 | — | 56 | 69.4 | 12.6 | 0.094 |
| 1 | On | 10 | 16 | 56 | 62.6 | 3.6 | 0.273 |
| 2 | On | 15 | 19 | 59 | 54.8 | 3.4 | 0.234 |
| (FIG. 3) | | | | | | | |
| 3 | Off | 10 | 16 | 56 | 47.2 | 2.4 | 0.266 |
| (FIG. 4) | | | | | | | |
| 4 | Off | 15 | 20 | 60 | 39.3 | 2.2 | 0.227 |
| 5 | On | 10 | 23 | 63 | 66.1 | 4.3 | 0.252 |
| (FIG. 5) | | | | | | | |
| 6 | On | 15 | 20 | 60 | 70.9 | 4.6 | 0.268 |
| (FIG. 6) | | | | | | | |
| 7 | Off | 10 | 30 | 70 | 47.5 | 2.7 | 0.239 |
| (FIG. 7) | | | | | | | |
| 8 | Off | 15 | 16 | 56 | 47.5 | 2.8 | 0.230 |

As indicated above, all of the samples were able to achieve a lower pressure drop and higher dynamic filtration property than the control, and many of the samples also achieved a higher filtration efficiency. In certain instances, such as with Samples 3-4 and 7-8, the filtration efficiency was slightly lower than the control value. Without intending to be limited by theory, it is believed that this is due to the lack of a charge during spinning, which resulted in a non-uniform distribution of the nanohairs on the fibers.

### Example 2

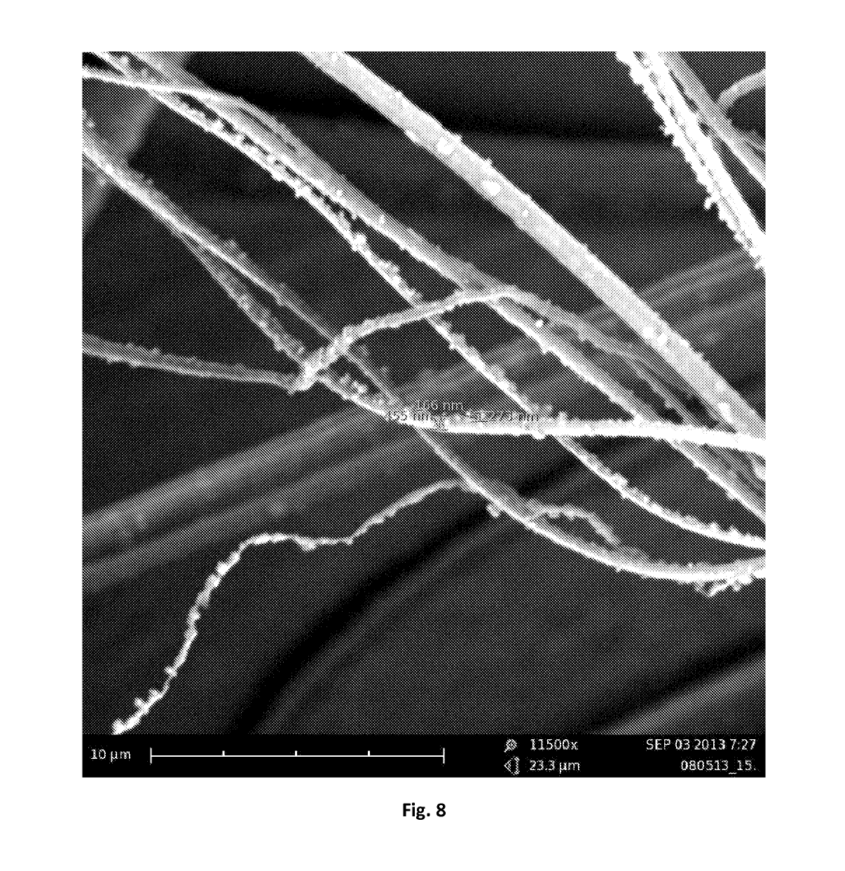

Twelve (12) types of fibrous webs (Samples 9—were formed as described in Example 1. Samples 10, 13, 16, and 19 contained 50 wt. % of the polypropylene masterbatch and 50 wt. % of the POSS masterbatch; Samples 11, 14, 17, and 20 contained 75 wt. % of the polypropylene masterbatch and 25 wt. % of the POSS masterbatch; and Samples 9, 12, 15, and 18 contained 75 wt. % of the POSS masterbatch and 25 wt. % of the polypropylene masterbatch. In all samples, the polypropylene masterbatch contained 97 wt. % polypropylene (Metocene™ MF650Y, Basell Polyolefins), 1.5 wt. % peroxide masterbatch, and 1.5 wt. % sodium stearate and the POSS masterbatch contained 20 wt. % POSS particles and 80 wt. % Metocene™ MF650Y. An SEM microphotograph of the resulting web of Sample 17 is shown in FIG. 8. To test the ability of the fibrous webs to enhance filtration properties, three-layer laminates containing the fibrous web sandwiched between two bonded spunbond webs. The spunbond webs each had a basis weight of 20 grams per square meter. The samples were also subjected to an electret treatment as described in Example 1. A control sample (Control) was also formed that contained a meltblown web (basis weight of 16 gsm) laminated between two spunbond webs (basis weight of 20 grams per square meter).

The filtration efficiency and pressure drop were determined in the manner set forth above. The results are shown in the table below.

| | | | | | Avg. | Avg. | Dynamic |
|---|---|---|---|---|---|---|---|
| | | | Basis Wt. of | Basis Wt. of | Filtration | Pressure | Filtration |
| | Process | Wt. % | Fibrous Web | Laminate | Efficiency | Drop | Property (mm |
| Sample | Charge | POSS | (gsm) | (gsm) | (%) | (mm H₂O) | H₂O)⁻¹ |
| Control | — | 0 | — | 56 | 69.4 | 12.6 | 0.094 |
| 9 | On | 5 | 16 | 56 | 76.0 | 5.0 | 0.285 |
| 10 | On | 10 | 20 | 60 | 76.9 | 5.0 | 0.293 |
| 11 | On | 15 | 14 | 54 | 55.0 | 3.7 | 0.216 |
| 12 | Off | 5 | 16 | 56 | 46.6 | 3.0 | 0.209 |
| 13 | Off | 10 | 14 | 54 | 53.2 | 3.5 | 0.217 |
| 14 | Off | 15 | 15 | 55 | 45.4 | 2.8 | 0.216 |
| 15 | On | 5 | 23 | 63 | 82.4 | 6.1 | 0.285 |
| 16 | On | 10 | 20 | 60 | 82.5 | 6.4 | 0.272 |
| 17 | On | 15 | 22 | 62 | 74.4 | 5.3 | 0.257 |
| 18 | Off | 5 | 14 | 54 | 46.9 | 2.7 | 0.234 |
| 19 | Off | 10 | 22 | 62 | 51.1 | 3.3 | 0.217 |
| 20 | Off | 15 | 28 | 68 | 63.5 | 5.3 | 0.190 |

### Example 3

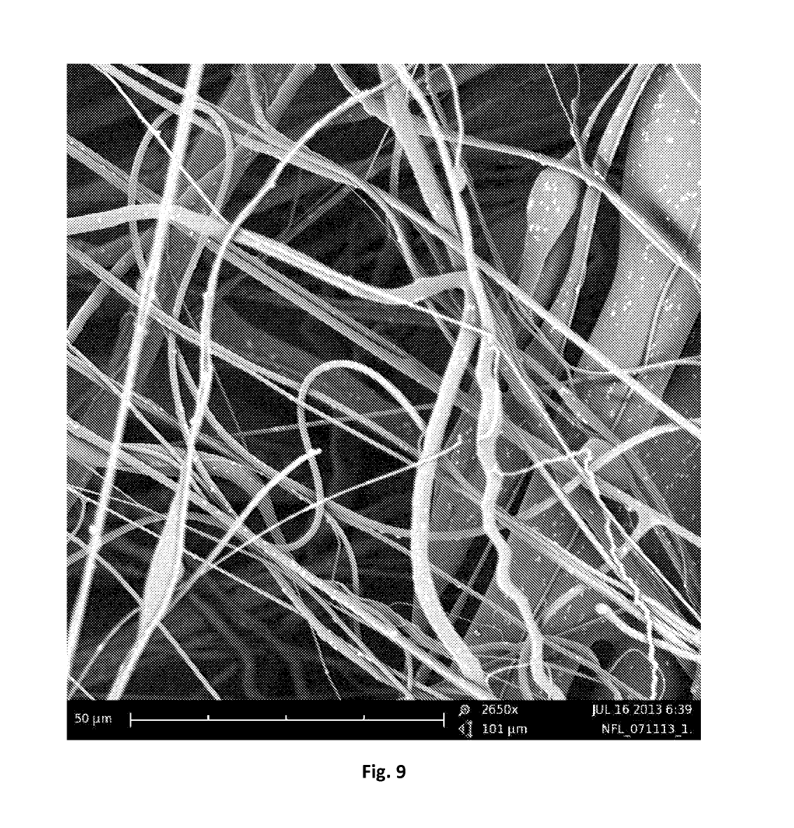

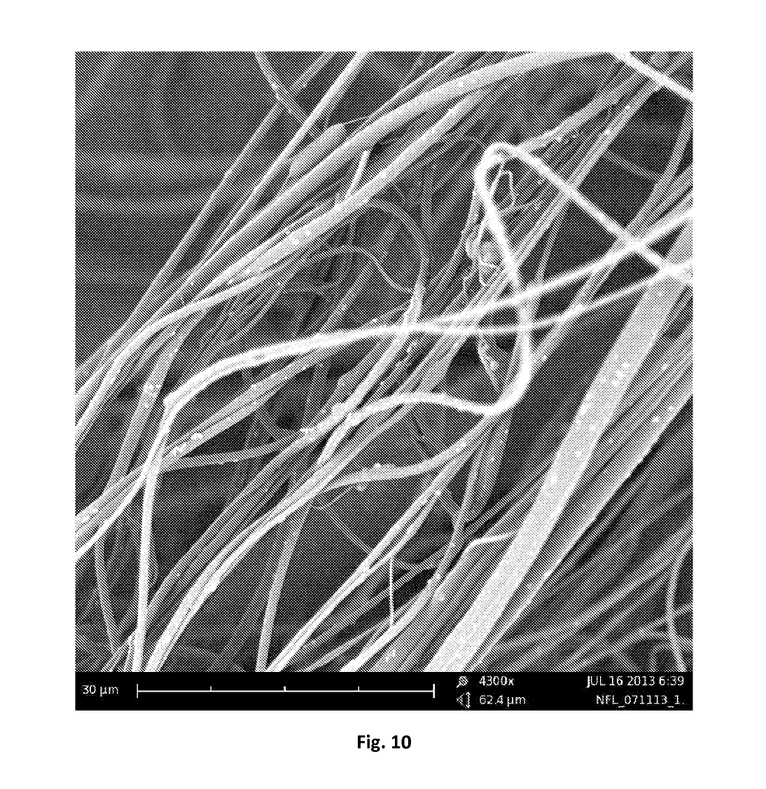

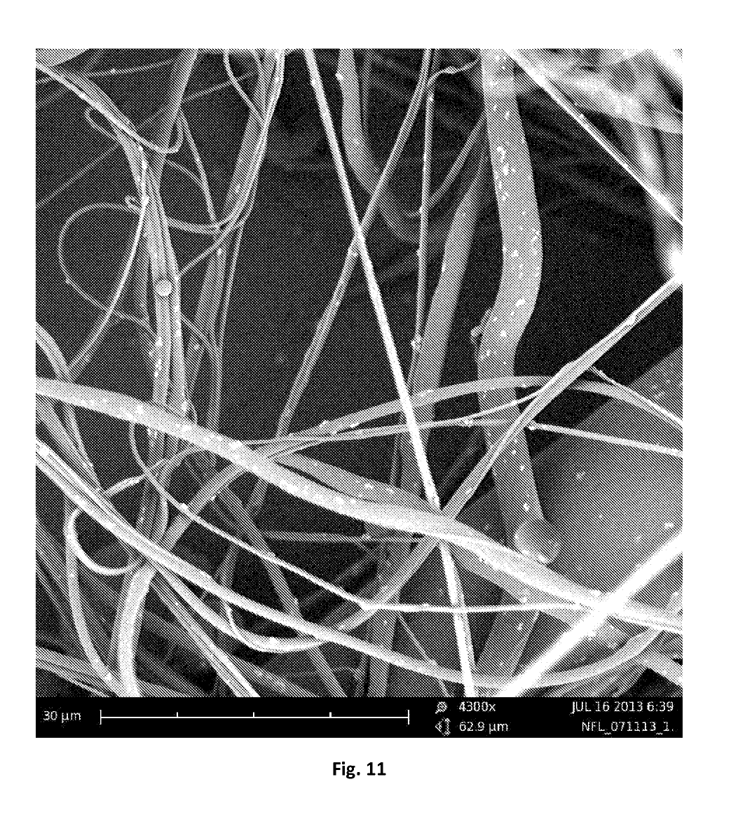

Various types of fibrous webs were formed by blending 80 wt. % of a polypropylene masterbatch and 20 wt. % of a titanium dioxide masterbatch. The polypropylene masterbatch contained 97 wt. % polypropylene (Metocene™ MF650Y, Basell Polyolefins), 1.5 wt. % peroxide masterbatch, and 1.5 wt. % sodium stearate and the titanium dioxide masterbatch contained about 10 wt. % titanium dioxide particles and 90 wt. % Metocene™ MF650Y. The spinneret temperature was 385° C. to 390° C., the flow rate was 8 milliliters per minute, and the rotation speed was 6000 revolutions per minutes. The fibrous web was formed on a spunbond web (20 grams per square meter) at a target basis weight of 24 grams per square meter. SEM microphotographs of the resulting fibers are shown in FIGS. 9-11. As shown, the nanohair topography that was achieved in Examples 1 and 2 was generally absent from the fiber surface.

While the invention has been described in detail with respect to the specific embodiments thereof, it will be appreciated that those skilled in the art, upon attaining an understanding of the foregoing, may readily conceive of alterations to, variations of, and equivalents to these embodiments. Accordingly, the scope of the present invention should be assessed as that of the appended claims and any equivalents thereto.

What is claimed is:

1. A fiber comprising an elongate structure that defines an external surface, wherein a plurality of nanohairs extend outwardly from the external surface of the elongate structure, and further wherein organofunctional nanoparticles form about 70 wt. % or more of the nanohairs and one or more thermoplastic polymers form about 70 wt. % or more of the elongate structure.

2. The fiber of claim 1, wherein the nanohairs have an aspect ratio of from about 1 to about 1000.

3. The fiber of claim 1, wherein the nanohairs have a width of from about 1 to about 500 nanometers.

4. The fiber of claim 1, wherein the nanohairs have a length of from about 100 to about 3,000 nanometers.

5. The fiber of claim 1, wherein the organofunctional nanoparticles include an organosiloxane oligomer.

6. The fiber of claim 5, wherein the organosiloxane oligomer is a polyhedral organofunctional silsesquioxane (“POSS”).

7. The fiber of claim 6, wherein the organosiloxane oligomer is cyclohexenyl-POSS, cyclohexenylethylcyclopentyl-POSS, trisilanol phenyl-POSS, octaisobutyl-POSS, phenylisooctyl-POSS, isooctylphenyl-POSS, isobutylphenyl-POSS, poly(dimethyl-co-methyl-co-methylethylsiloxy)-POSS, methacrylfluoro-POSS, or a combination thereof.

8. The fiber of claim 1, wherein the organofunctional nanoparticles have a size of about 50 nanometers or less and a density of about 1.8 grams per cubic centimeter or less.

9. The fiber of claim 1, wherein the one or more thermoplastic polymers include a polyolefin.

10. The fiber of claim 1, wherein the fiber further comprises a charge stabilizer.

11. The fiber of claim 10, wherein the charge stabilizer is a salt or ester of an organic carboxylic acid.

12. The fiber of claim 1, wherein the fiber is a nanofiber or microfiber.

13. A nonwoven web comprising the fiber of claim 1.

14. The nonwoven web of claim 13, wherein the nonwoven web has a basis weight of from about 15 to about 50 grams per square meter.

15. The nonwoven web of claim 13, wherein the web is electret-treated.

16. A filtration media comprising the nonwoven web of claim 13.

17. The filtration media of claim 16, wherein the media is a composite that includes the nonwoven web laminated to a layer of a meltblown web, spunbond web, film, strands, or combination thereof.

18. The filtration media of claim 17, wherein the nonwoven web is laminated to a spunbond web.

19. The filtration media of claim 16, wherein the filtration media exhibits a filtration efficiency of about 80% or more.

20. The filtration media of claim 16, wherein the filtration media exhibits a pressure drop of about 50 mm H₂O or less.

21. The filtration media of claim 16, wherein the filtration media exhibits a Dynamic Filtration Property (“DFP”) of about 0.15 (mm H₂O)⁻¹ or more.

22. A method for forming a fiber, the method comprising spinning a polymer composition to form an elongate structure having an external surface, wherein the polymer composition comprises organofunctional nanoparticles embedded within a matrix of one or more thermoplastic polymers, and further wherein a plurality of nanohairs extend outwardly from the external surface of the elongate structure.

23. The method of claim 22, wherein the spinning includes ejecting the polymer composition from a rotating member by centrifugal force onto a collection surface.

24. The method of claim 22, further comprising applying an electrostatic charge to the polymer composition during spinning.

25. The method of claim 24, wherein the electrostatic charge is applied to the collection surface.

26. The method of claim 22, further comprising subject the fiber to an electret treatment after spinning.

27. The method of claim 22, wherein the organosiloxane oligomer is a polyhedral organofunctional silsesquioxane (“POSS”).

28. The method of claim 22, wherein the one or more thermoplastic polymers include a polyolefin.

29. The method of claim 22, wherein the organofunctional nanoparticles constitute from about 10 wt. % to about 25 wt. % of the polymer composition.
